(19) United States
(12) Patent Application Publication
(10) Pub. No.: US 2002/0104865 A1
(43) Pub. Date: Aug. 8, 2002

(54) Tape dispenser having an unpacking blade

(76) Inventor: Harrison Huang, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/777,820

(22) Filed: Feb. 7, 2001

(51) Int. Cl. B26F 3/02

(52) U.S. Cl. 225/65; 225/56; 225/66

(57) ABSTRACT

A tape dispenser is formed of a main body, a cutter, and an unpacking blade. The main body has a front portion and two side portions for holding pivotally a tape reel. The cutter is mounted on the front portion to dispense the tape. The unpacking blade is located at the front end of the outer side of one of the two side portions of the main body. The unpacking blade is used to cut tapes or cords which are used in packaging goods.

### FIELD OF THE INVENTION

The present invention relates generally to a tape dispenser, and more particularly to a tape dispenser having an unpacking blade.

### BACKGROUND OF THE INVENTION

The adhesive tapes are indispensable in packaging goods for shipment. In the process of unpacking the packages, knife or pointed object is often used to cut or sever the tapes to facilitate the opening of the packages. For this reason, a tape dispenser with an unpacking blade is a handily adjunct.

### SUMMARY OF THE INVENTION

The primary objective of the present invention is to provide a tape dispenser with a means to sever tapes of a package.

The tape dispenser of the present invention comprises a main body, a cutter, and an unpacking blade. The main body has a front portion for holding a tape. The cutter is mounted at the front portion of the main body to sever the tape that is dispensed. The unpacking blade is located at the front end of the outer side of one of two side portions of the main body. The unpacking blade is intended to cut the tapes or cords that are used in packaging goods.

### BRIEF DESCRIPTION OF THE DRAWINGS

FIG. 1 shows a perspective view of the present invention.

FIG. 2 shows a side view of the present invention.

FIG. 3 shows a top plan view of the present invention.

### DETAILED DESCRIPTION OF THE INVENTION

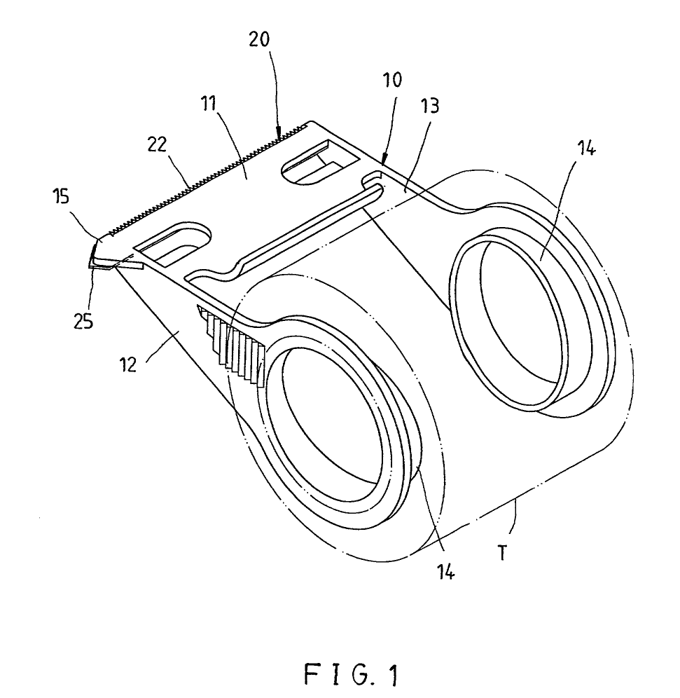

As shown in FIGS. 1-3, a tape dispenser of the present invention comprises a main body 10, a cutter 20, and an unpacking blade 25.

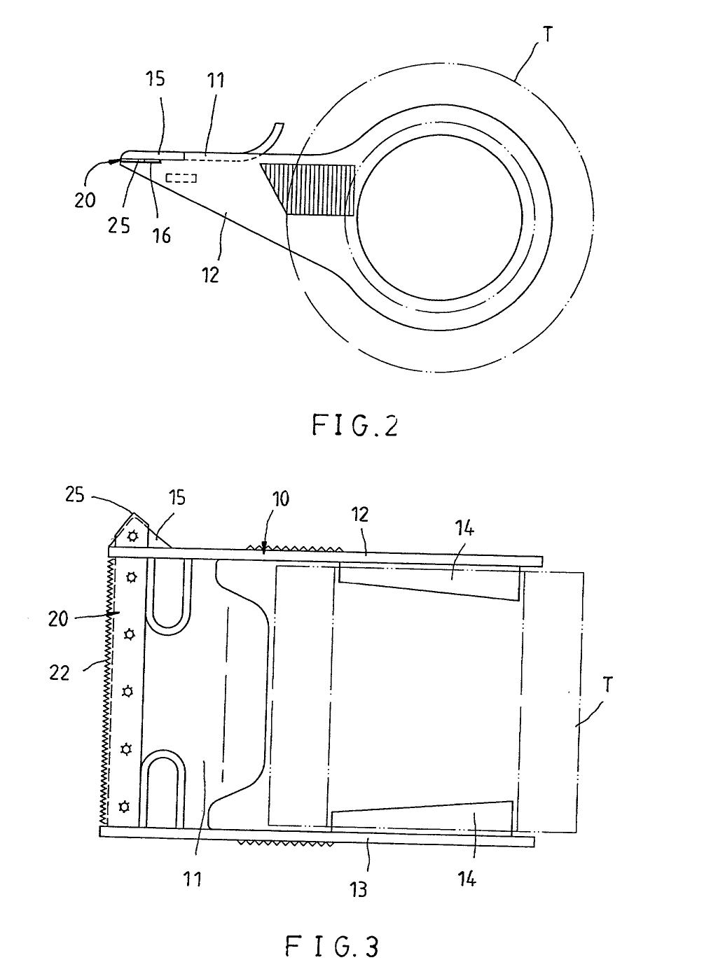

The main body 10 is integrally made of a plastic material by injection molding and is provided with a horizontal front portion 11, and two side portions 12 and 13 which are connected with two sides of the front portion 11 and are perpendicular to the front portion 11. The side portions 12 and 13 are parallel to each other and are extended rearward from the front portion 11. The side portions are provided in the inner side of the rear end with a round projection 14 for holding a tape reel “T”, which is pivoted between the two side portions 12 and 13. The side portion 12 is provided at the foremost end of the outer side with a triangular support piece 15 which is coplanar with the platelike front portion 11. The side portion 12 is further provided with a slot 16 which is located under the support piece 15, as shown in FIG. 2.

The cutter 20 is mounted in the bottom of the front portion 11 and is provided with a punch hole which is then pierced into the front portion 11. The cutter is fastened with the front portion 11. The cutter 20 has a toothed portion 22 extending beyond the front edge of the front portion 11. The toothed portion 22 is intended to sever a piece of tape which is dispensed by the reel “T”. The cutter 20 has a length greater than the width of the front portion 11, and a left end which is jutted out of the side portion 12 from the slot 16 to rest against the underside of the support piece 15. The end edge is triangular, with two inclined sides slightly being located beyond the outer edge of the support piece 15 by 0.5 mm, thereby resulting in formation of the unpacking blade 25.

The dispenser of the present invention thus has dual purposes. In light of the unpacking blade 25 being extended beyond the support piece 15 by only 0.5 mm, the unpacking blade 25 does not cut accidentally the goods contained in the package which is being unpacked with assistance of the unpacking blade 25. In addition, the unpacking blade 25 is similar in construction to the toothed portion 22 of the cutter 20, the unpacking blade 25 is not a safety hazard. The unpacking blade 25 may be made of a metal or a triangular rigid plastic piece extending from the front end of the outer side of the plastic main body 10.

What is claimed is:

1. A tape dispenser comprising:
a main body having a front portion and two side portions opposite to each other and extending rearwards from two sides of said front portion, said two side portions being provided with a tape reel pivoted therebetween;
a cutter of a metal material and mounted on said front portion of said main body, said cutter having a toothed portion extending beyond the front edge of said front portion for severing a piece of tape dispensed by said tape reel; and
an unpacking blade located at a front end of an outer side of one of said two side portions of said main body, said unpacking blade being intended for use in cutting tapes, cords, and the like, which are used in packaging.

2. The tape dispenser as defined in claim 1, wherein said cutter is greater in length than said main body and is provided with one end extending beyond the corresponding side portion to form said unpacking blade.

3. The tape dispenser as defined in claim 1, wherein said side portion corresponding to one side of said unpacking blade is provided with a support piece extending outward therefrom to facilitate the resting of the extended portion of said cutter; wherein the edge of said unpacking blade is slightly extended beyond the outer edge of said support piece.

4. The tape dispenser as defined in claim 2, wherein said main body is integrally made of a plastic material; wherein said unpacking blade is of a triangular piece body extending from a front end of an outer side of one of said two side portions of said main body.
